(19) United States
(12) Patent Application Publication
(10) Pub. No.: US 2008/0172613 A1
(43) Pub. Date: Jul. 17, 2008

(54) SYSTEM OF PHONETIC NOTATION FOR MULTITUDE OF LANGUAGES AND METHOD THEREOF

(76) Inventor: ZBIGNIEW STEIN, (US)

Correspondence Address: ZBIGNIEW STEIN, 9332 SANDY RUN RD., JUPITER, FL, 33478, US

(21) Appl. No.: 11/671,714

(22) Filed: Feb. 6, 2007

Related U.S. Application Data
(60) Provisional application No. 60/884,715, filed on Jan. 12, 2007.

(51) Int. Cl. G06F 3/00

(52) U.S. Cl. 715/708

(57) ABSTRACT

Disclosed is a system of phonetic notation common for a multitude of languages and a method to create such a notation system common for a chosen group of languages.

### CROSS-REFERENCE TO EXISTING APPLICATION

This specification claims the benefit of provisional patent application Ser. No. 60884715 filed 2007 Jan. 12 by the present inventors.

### FEDERALLY SPONSORED RESEARCH

Not Applicable

### BACKGROUND

1. Field of the Invention

The present invention relates to common phonetic notation which may be created for a group of arbitrarily chosen languages.

2. Description of the Prior Art

There were many attempts to create a common phonetic writing system for groups of languages or a particular phonetic writing system for a language that don't have it like English. A good example may be International Phonetic Alphabet (IPA) or similar Webster system used in various dictionaries to teach the proper pronunciation.

They are good for this purpose, but they use the sets of special characters not found on computer keyboards. Also, however they express the sound with high fidelity they are not simple and easy to learn. To decipher one word to find the proper pronunciation is not a big problem but to use it for writing may be. Besides that there were a lot of attempts to apply various systems to English to make it phonetic. Some of them are using Non-Roman alphabets usually created for this purpose with more than 26 characters.

One of well known example could be Initial Teaching Alphabet (ITA) developed by Sir James Pitman and supported by the Ford Foundation. This one is using 24 of 26 existing roman letters plus 20 new letters consisting mostly of typographically linked diagrams. Others are using existing English alphabet with color enhancement of the letters.

This system however relates more to a learning tool for English speaking students, than to a tool that may be used to create a global language.

Another reform of English language was recommended by the Government of Her Majesty Queen of England having in mind the creation of a common language for the European Union. Their recommendation was replacement of soft /c/ with /s/ and a hard /c/ with /k/ and also replacement of /ph/ with /f/ and /th/ with /z/. The last one is however highly discussable. They recommended also discarding the silent /e/ on the end of words (French heritage). These proposals are mostly acceptable, but not sufficient to create a fully phonetic language for the global use.

The other attempts were directed toward a creation of artificial languages. The best known example would be Esperanto created by Dr. Ludwik Zamenhoff (Bialystok, Poland).

Esperanto is based on European Roman languages and precisely built with perfect grammar without exceptions. Although the cores of the words in this language are mostly Latin, but its still a new language to learn that is very tough, time consuming and for most Americans even unthinkable. That's why Esperanto although still alive has a limited popularity.

### OBJECTIVES AND ADVANTAGES

Many systems for particular languages or their groups were proposed but, none of them gain enough popularity. Several objectives and advantages of this system are evident.
a) System allows the creation of unified phonetic notation for a group of languages.
b) The languages assigned to the main group may be arbitrarily chosen.
c) The extention of the system may be created for sub-groups of associated languages.
d) The languages assigned to sub-groups may be arbitrarily chosen.

e) System is based only on the characters (letters and the other writing signs) appearing on a standard computer keyboard.

Further objectives and advantages of the invention will become apparent from a consideration of ensuing description of preferred embodiment.

### SUMMARY

Present system uses single characters and character pairs to provide the phonetic notation which may be common for arbitrarily chosen group of languages.

### BRIEF DESCRIPTION OF THE DRAWINGS

FIG. 1

Table 1. Single character sounds.

FIG. 2.

Table 2. Double character sounds.

FIG. 3.

Table 3. Sub-group extension of Table 2.

FIG. 4.

Table 4. The names of the letters of the sub-group extension.

### DETAILED DESCRIPTION OF THE DRAWINGS

Table 1 presents the set of sounds being represented by a single letter.

Table 2 presents the set of sounds being represented by a letter and a character.

Table 3 presents the set of sound being the European sub-group extension for a sounds represented by letter and a character.

Table 4 presents the names of the letters of the European sub-group extension.

### DESCRIPTION OF THE PREFERRED EMBODIMENT

The preferred embodiment is created by applying the present system to a chosen group of languages comprising: English, Italian and Spanish.

The preferred embodiment uses single Roman letters and a pairs of a letter and a character (i.e. a letter with a letter or a letter with writing sign) to provide the phonetic notation which may be common for an arbitrarily chosen group of languages. The noted writing signs are silent, but when appearing immediately after the character (with no space) will modify this character.

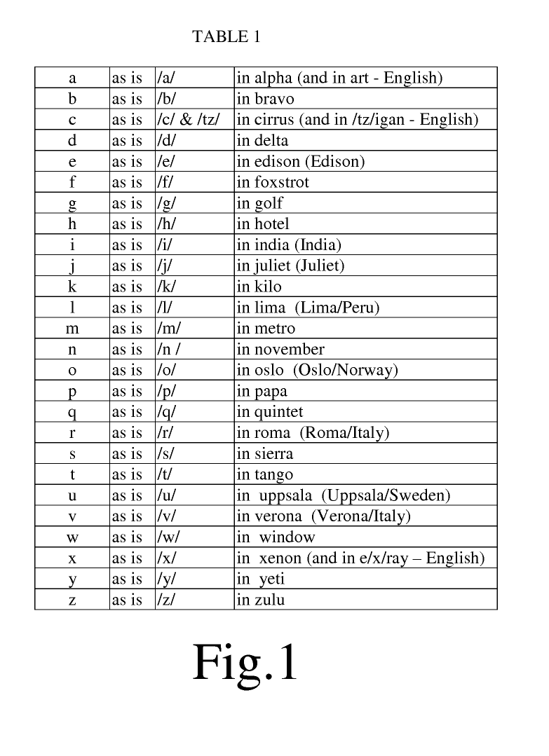

In the preferred embodiment the set of sounds represented by single letter is illustrate in Table 1 (FIG. 1).

The assigned words may be also used for spelling purpose.

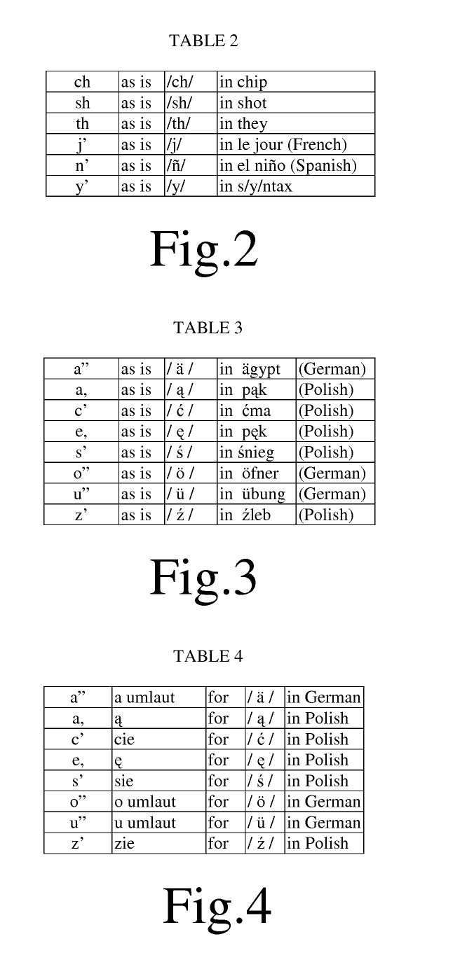

The set of sounds represented by a letter and a character is illustrated in Table 2 (FIG. 2).

An extension for a sub-group of European associated languages comprising: Danish, French, German, and Polish is illustrated in Table 3 (FIG. 3)

The European sub-group two character symbols are created this way that they remind the special characters used in particular languages. This way they don't have to be learned, just accepted.

All other languages which sound may not be successfully recorded with chosen languages alphabet with its European sub-group extension will form other sub-groups. The additional rule for this embodiment will be that the signs containing any form of coma like ‘ “, and ; will have to be preceded by space. Otherwise they will be interpreted with preceding letters as a sound represented by two characters. That makes 26×4=104 notations for new sounds minus 11 already used leaves 93 symbols for other sub-groups than European. The usage of upper case characters is possible however not necessary and not recommended.

The names of letters in the alphabet for this embodiment may be standardized so every consent will be followed by vowel /e/.Vowels may be named by itself with only one exception for y′that may be called y'ge. It will look like that: a be ce de e fe ge he i je j'e ke le me ne n'e o pe qe re se te u ve we xe ye y'ge ze.

For European sub-group extension the letters may be called as illustrated in Table 4 (FIG. 4).

The chosen group of languages like English, Italian, Spanish (and possibly additional other languages) with the extension for European sub-groups of associated languages like French, German, Polish (and possibly additional other languages) will use the same phonetic notation.

This will allow enriching each language by borrowing words from the other languages leading in future to creation of a very rich language based on many cultures.

It's also possible to include other sub-groups of languages what may lead to creation of ever growing global language.

For today's needs the notation applied to English language may create an international cyberspace language based on today's English which is already commonly known. Such a language may be called “komplish” as a composition of komputer (i.e. computer written in new notation) and English. Komplish will sound somewhat different from British, American or Australian English when red by foreigners or by voice synthesizer, but three versions of English mentioned above differ already and nobody can do anything about it. The main purpose here is to create something that will unify the notation for several languages not just the perfection of English language. Besides that, cyberspace is exterritorial.

On the other hand it will be the language based on logic versus the language based on tradition.

This new language built on application of preferred embodiment will be based on English language—the most popular, but unfortunately not the best for it. Using English however due to its popularity still seems to be a good idea. The applied system only changes the notation making it common for a number of other languages. Thanks to that, English may be enriched again like in times of queen Elizabeth the First, but this time with those most perfect Latin based languages like Italian and Spanish instead of French which itself is very far from perfection almost like today's English.

Besides that, such a global language may be easier to learn in writing for the people outside European countries especially for Asians who are struggling with today's English and for sure that they will cordially welcome this new notation. Their aspirations, strength and influence on the global economy can't be ignored. Actually the Japanese and Chinese hold most patents on computerized methods of translation between their languages and English. The new notation would solve a lot of existing problems and make this process more perfect.

The changes of the language itself may but doesn't have to be made immediately. One recommendation here will be modification of tenses. In a real world there are only three tenses: past, present and future. There is no need to express it in special grammatical construction if for instance something started in the past and still takes place. It may be simply explained in the next sentence. It's a Latin heritage that makes unnecessary complication of the English language leading to 16 tenses in active voice and another 16 in passive voice.

This heritage affects not only English, but also German, French, Spanish and all the Latin based languages. Of course all this tenses may be still used, but limitation to simple past, simple present and simple future would make a new English based global language simpler to learn and use. Actually this is the way people learning English as a second language tends to use tenses—for them it's quite natural.

Other recommendation would be the way to solve the problem of ambivalence. The solution here would be the idea that only the verbs should maintain its original form. A good example would be a classical see, c and sea where see should be maintained, c should be mention as a letter c and the sea should be mentioned as the sea of water. In the time of globalization and especially in the third phase of it which is taking place now there is a growing need for a global language. In the time of Hellenistic culture it was old Greek replaced later in the times of Roman Empire with Latin. In the latest centuries French was a dominating language until the Second World War when it was replaced with English, which now has a chance to become a global language.

However the presented system in its preferred embodiment may help English to preserve its position and reach the status of a global language while in its present form it creates some problems. The best example of it would be the level of illiteracy in United States—its 10%. It means that 30 million people can't learn to read and write in their own language. The main reason is that they learn to recognize the image of the word instead of actually reading it, which in turn prevents them to effectively learn the other languages. This is return to hieroglyphs—a major step back since mankind figured out how to write phonetically what happened even before ancient Greeks and Romans. Besides that, European children those who have their language written phonetically are reading from the classics while American children are struggling at a “Dick and Jane” level. Our schools do not recover from this handicap. American university students are at the educational level of European high school students. Many American children never learn to read adequately. Functional illiteracy is a heavy burden for these children to carry when they reach adulthood and a problem for this country as well, both socially and economically.

That's why the preferred embodiment primarily intended to be used as a global cyberspace language may be gradually introduced to school and taught parallel to the classic English. It will be the decision of future generations if it replaces it totally in the future.

In the beginning the English speaking people (those lucky who already learned successfully how to read and write) may be reluctant to use a new notation, but a growing number of all the other internet users for whom English is a second language will learn it with ease due to the similarity to the one they are already using and will force the others to use it! Actually the foreigners tend to know two English languages: one spoken and one written which they usually remember in the way how it would be read in their language.

Since proposed common notation is very close to one used in European languages with a small, easy to learn differences for each one, the new notation will be almost natural for continental Europeans. For those who prefer to write in today's English a translators may be created that will produce a perfect transcription into new notation based on a special dictionary stored in computer memory. The reversed process is possible but with some ambivalence due to the fact that a word written in new phonetic notation may refer to more than one word written in today's English. In this case, all these possibilities have to be shown on the screen and users have to choose them interactively. In this case the voice synthesizer may be useful for reading this new notation phonetically for the user. The voice communication will be intact because no matter what notation is used it's still a form of spoken English.

There will be a necessity to write spellcheckers, dictionaries, tutorials, voice synthesizing and recognizing software and a lot of other programs and manuals. All of this multiplied by over hundred fifty main languages of the planet will mean multi-terabytes of software to be written by a number of software companies and a tons of books and other printed materials published. Even if these products aren't expensive (and they shouldn't) but multiplied by a billions of future users will give quite a large sum of money to be earned by companies and even motivated individuals who will see this opportunity early enough. The other manner how this system and its embodiments may be used is to create more perfect man-machine interface when the voice recognition device will write the commands in the proposed notation. This will free man from the necessity of learning the art of typing.

Actually due to the problems with English language we don't have a perfect voice communication with our computers. The proposed notation may be easily handled by a voice analyzers and synthesizer creating more perfect machine-men communication. It may be used also for communication between machines (robots) in which the man may be involved interactively. Thanks to common notation it may improve the automatic translation between the languages. It may create a modern Babel tower with this difference that the men and machines will understand each other. This is something that NASA would need for future manned international space missions with the usage of robots, but coming back to earth, generally it may help us in the process of globalization. The best existing example of usage of the preferred embodiment will probably be the first letter wrote in new notation cited below:

Atlantic, 22 Jun. 2006

dier tom,

yu ar th ferst person in the world hu wil ry'civ ferst leter rityn in this nyu global lengwyj, bat yu wont bi th ferst wan tu rid it. it is my wayf eva hu flays with mi and rids it bifor yu tu meyk nesesery korekshy'ns. this noteyshy'n wil work es wel for spanish, italien end with a speshy'l extenshy'n for e hendful of ather yuropien lengwy'jy's like french, german and poulish. it wil nid a lot of werk to introdyus it , bat this is the bigining end ay biliv a gud wan. yur mishy'n wil bi to werk with inglish lengwy'j wich yu shud fulfil good lak end si yu sun. doctor e. komplish

### CONCLUSIONS, RAMIFICATION AND SCOPE

The invention allows for the creation of a common notation for an arbitrarily chosen group of languages. Such a notation may be simple and easy to learn when is based on a roman letters of a Standard English computer keyboard. It may use single 26 letters or their combinations with other character which may be a letter or a chosen writing sign not representing any particular sound by itself like , ”; ’ or other.

The particular embodiment has been illustrated and described in example only and is not intended to be limiting. It will be apparent to those skilled in the art that various changes and modification can be made without departing from the scope of the present invention. modifications that fall within the scope of the present invention.

What is claimed is:

1. A system of phonetic notation based on characters appearing on a computer keyboard common for multitude of languages comprising:
(a) a set of sounds represented by a single said character;
(b) a set of sounds represented by two said characters.

2. A phonetic system of claim 1 wherein said computer keyboard is a standard national computer keyboard.

3. A phonetic system of claim 1 wherein said computer keyboard is a standard US English computer keyboard.
